(19) United States
(12) Patent Application Publication
(10) Pub. No.: US 2006/0016551 A1
(43) Pub. Date: Jan. 26, 2006

(54) Phenolic lamination process for hot gas components

(76) Inventors: Donald J. Christensen, Phoenix, AZ (US); Jason A. Gratton, Chandler, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/897,499

(22) Filed: Jul. 23, 2004

(51) Int. Cl. B29C 65/00; B32B 37/00; B32B 38/04; B32B 31/00

(52) U.S. Cl. 156/252; 156/281; 156/325; 156/264

(57) ABSTRACT

A method is provided for fabricating a missile component having a flow path therein. The resulting component is a phenolic laminate constructed of layers having cavities formed therein. The method includes bonding a plurality of phenolic laminates to one another in a predetermined order and in a predetermined configuration, each phenolic laminate having a cavity formed therein, wherein the bonded phenolic laminates form the missile component and the cavities define the flow path.

### STATEMENT REGARDING FEDERALLY SPONSORED RESEARCH OR DEVELOPMENT

This invention was made with Government support under F0863099C0027 awarded by the Air Force Research Laboratory. The Government has certain rights in the invention.

### FIELD OF THE INVENTION

The present invention relates to components made from phenolic and, more particularly, to a method of manufacturing components from phenolic.

### BACKGROUND OF THE INVENTION

Different types of missiles have been produced in response to varying defense needs. Some missiles are designed for tactical uses, while others are designed for strategic uses. Missiles typically have rocket motors that use hot propellant gases to thrust the missile forward. For missiles with guidance capabilities, valves may be employed that open or close to thereby redirect propellant gases to steer the missile in a desired direction.

Historically, missiles using thrust control valves have employed relatively simple geometric designs. The exhaust valves associated with these missile-types include component liners that define relatively simple flow paths (i.e., cylindrical, tubular, conical). Traditionally, component liners have been constructed of phenolic, which serves as an insulator to other exhaust valve components as well as an ablative that burns off when exposed to the propellant gases. Phenolic component liners are typically made using one of two methods. With the first method, the phenolic is compression-molded around a solid insert that is shaped like the flow path, and the solid insert is then pulled out of the resulting flow path. With the second method, the desired component liner shape is machined into a solid piece of phenolic.

Recently, the desire has increased for smaller missiles having greater agility and the ability for longer flight missions. As a result, missile designs have evolved to incorporate components having complex shapes in order to provide the desired precision guidance capabilities within these space constraints. These components may include flow paths having, for example, L-shaped bends, S-shaped bends, or any one of numerous other complex shapes.

Although the aforementioned methods are adequate to produce phenolic component liners having simple flow paths, the methods are not as useful in the manufacture of phenolic component liners having complex flow paths. For example, in cases where the component is manufactured by a compression-molding process, the solid insert that is used may not be removable without inflicting damage to the component. Specifically, the solid insert may become trapped in the complex flow path. In the case where a machining process is employed, machining these complex flow paths into a solid piece of phenolic may be relatively difficult and time-consuming. Consequently, manufacturing costs may increase.

Thus, there is a need for a method of manufacturing missile components that have one or more complex flow paths without damaging the component. It is also desirable to have a cost-efficient method for manufacturing such missile components that may be implemented for mass production. The present invention addresses one or more of these needs.

### SUMMARY OF THE INVENTION

Methods for fabricating a component having a flow path therein are provided. In one embodiment, and by way of example only, the method includes bonding a plurality of phenolic laminates to one another in a predetermined order and in a predetermined configuration, each phenolic laminate having a cavity formed therein, wherein the bonded phenolic laminates form the missile component and the cavities define the flow path.

In another exemplary embodiment, the method includes stacking a first phenolic laminate having at least one cavity on top of a second phenolic laminate, the cavity having a predetermined shape, and adhering the first and second phenolic laminates to one another.

In yet another exemplary embodiment, applying an adhesive to a first one of a plurality of phenolic laminates, each laminate having at least one cavity formed therein, aligning the cavity of a second one of the plurality of phenolic laminates with at least a portion of the cavity of the first phenolic laminate, and pressing the first and second phenolic laminates against one another to bond the first and second laminates together.

Other independent features and advantages of the preferred method will become apparent from the following detailed description, taken in conjunction with the accompanying drawings which illustrate, by way of example, the principles of the invention.

### BRIEF DESCRIPTION OF THE DRAWINGS

FIG. 1 is a cross section of a portion of a propulsion section of a missile;

FIG. 2 is a close up view of a valve nozzle that may be implemented in the missile depicted in FIG. 1 that has been manufactured according to one embodiment of the inventive method;

FIG. 3 is a flowchart depicting an exemplary embodiment of the overall process that may be used to manufacture the valve nozzle shown in FIG. 2; and

FIGS. 4A-4J are perspective views of phenolic laminates that correspond with laminations that make up the valve nozzle of FIG. 2.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. For illustration purposes only, the invention is described herein as being used to manufacture a thrust assembly component that may be employed on a missile, however, it will be understood that the method may be used to manufacture any component that may be exposed to extreme high temperatures, such as for tactical, strategic, or long range missiles, any type of thrust-propelled craft, such as spacecraft and torpedoes, or other types of components.

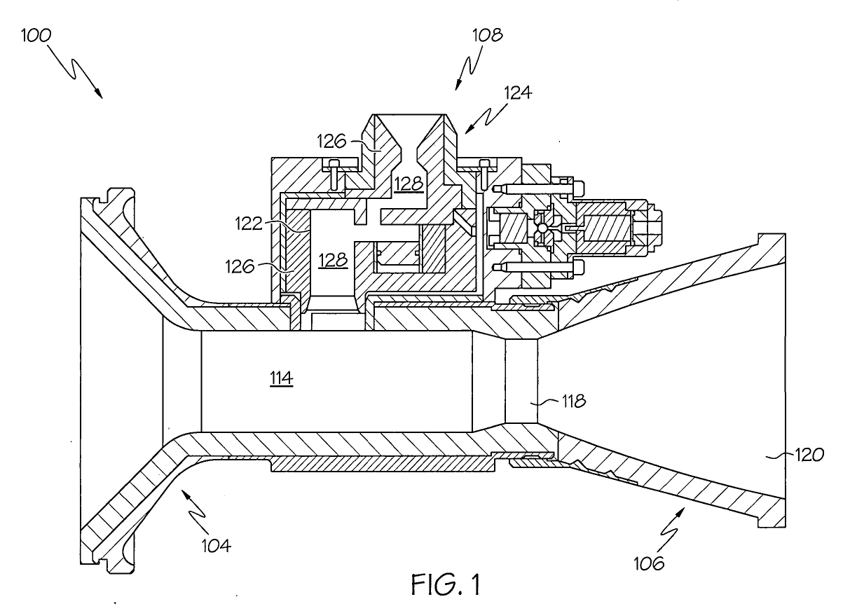

FIG. 1 is a cross section of a portion of a propulsion section of a missile. The propulsion section 100 includes a blast tube 104 coupled to a nozzle 106. The blast tube 104 further includes at least one thrust assembly 108 that is coupled thereto and in fluid communication with the blast tube 104. Each of these components will now be described in further detail.

The blast tube 104 is generally cylindrical in shape and includes a channel 114 therethrough that is configured to receive propellant gases from a non-illustrated motor, such as, for example, a solid rocket motor. The motor may include a fuel source that, when ignited, produces propellant gases and directs the gases into the blast tube 104. In the depicted embodiment, a portion of the propellant gases are directed through the blast tube 104 to the nozzle 106. As will be discussed more fully below, the remaining portion of the propellant gases are directed into the thrust assembly 108.

The nozzle 106 is coupled to the blast tube 104. In the depicted embodiment, the nozzle 106 is generally funnel-shaped and includes an inlet throat 118 in fluid communication with the blast tube 104 and an outlet 120 through which the propellant gases that enter the nozzle 106 may escape. When the propellant gases escape through the outlet 120, thrust is generated that propels the missile.

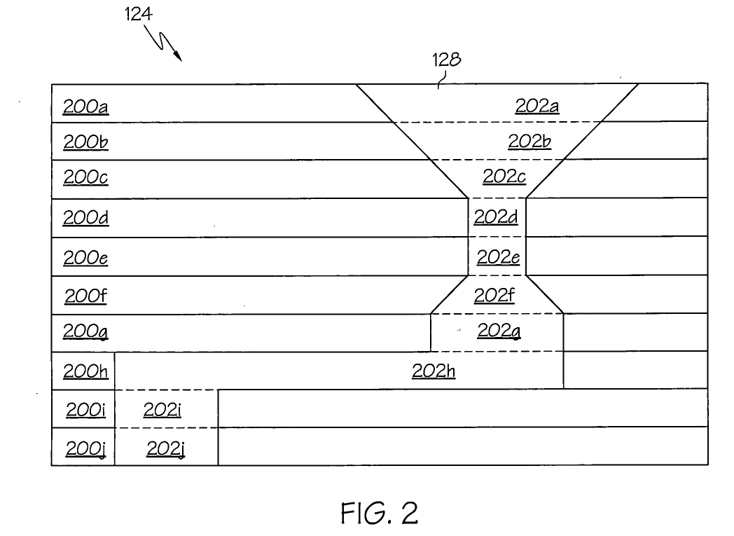

As was noted above, another portion of the propellant gases produced in the non-illustrated motor is directed to the thrust assembly 108. The thrust assembly 108 includes at least a main inlet duct 122 and a valve nozzle 124. Both the main inlet duct 122 and valve nozzle 124 preferably have a liner 126 which defines a flow passage 128. The flow passage 128 is shaped to divert a portion of the propellant gases from one direction to at least another. The flow passage 128 shape may also be configured to provide fine control of the pitch, yaw, roll, and thrust of an in-flight missile. In smaller missile configurations, the flow passage 128 may include any one of numerous shapes having any number of twists, turns, and bends. For instance, the flow passage 128 may be S-shaped, coil-shaped, or may include the two L-shaped bends and convergence/divergence, as shown in FIGS. 1 and 2.

Turning to FIG. 2, a close-up view is provided of the valve nozzle 124 constructed according to a particular preferred embodiment of the inventive method. The valve nozzle 124 is a laminated structure formed of a plurality of phenolic laminates 200a-200j. In the depicted embodiment, each laminate 200a-200j has a cavity 202a-202j formed therein. The cavities 202a-202j, together, form the flow passage 128. It will be appreciated that in other embodiments one or more of the laminates 200a-200j may not include a cavity 202, or one or more of the laminates 200a-200j may include two or more cavities 202. The number and size of the cavity (or cavities) 202 in each laminate 200a-200j may vary depending on the particular component being manufactured. It will additionally be appreciated that various other features, or partial features, in addition to, or instead of, cavities 202 may be formed into each laminate 200a-200j.

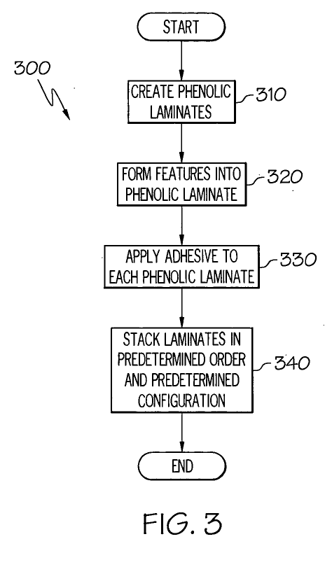

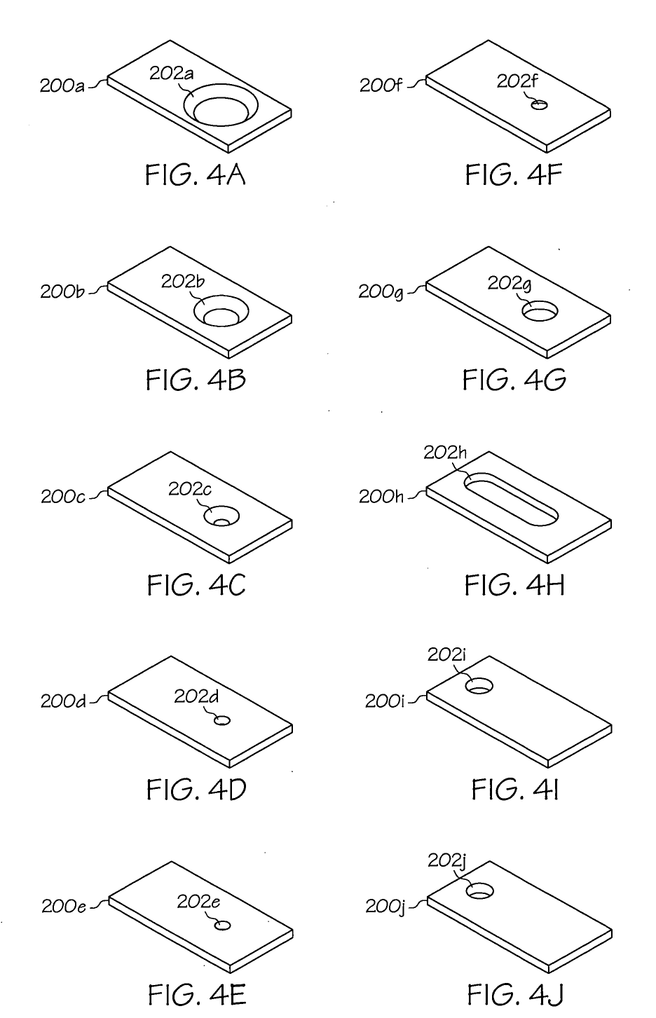

The overall inventive process 300 for constructing the valve nozzle 124 is illustrated in FIG. 3 in flowchart form, and will now be described in conjunction with FIGS. 4A-4J. It should be understood that the parenthetical references in the following description correspond to the reference numerals associated with the flowchart blocks shown in FIG. 3, and that the phenolic laminates shown in FIG. 4A-4J correspond to the phenolic laminates 200a-200j referenced in FIG. 2.

Initially phenolic laminates 200a-200j of various quantities are created. (310). Each phenolic laminate 200a-200j is preferably made from composite material, such as glass or carbon reinforced phenolic prepreg, that has been formed, molded, compression-molded, or machined into a single layer of phenolic, and may vary in thickness depending, for example, on its placement in the final laminated structure. Each phenolic laminate 200a-200j preferably has flat surfaces to provide a maximum surface area with which to contact. The flat surfaces also decrease the likelihood of air pockets forming between the phenolic laminates in a final assembled laminated structure.

Once the phenolic laminates 200a-200j are created, or simultaneously therewith, the cavities 202a-202j, and/or various other features or partial features, are formed in the phenolic laminates 200a-200j (320). It will be appreciated that the cavities 202a-202j may be similar in size, shape, and location, or may vary in shape and/or size and/or location. For example, in the embodiment of FIGS. 4A-4J, the phenolic laminates 200a-200c shown in FIGS. 4A-4C have circular cavities 202a-202c of varying sizes formed on the right side of the laminates 202a-202c. In addition, each of these cavities 202a-202c has beveled walls (shown in FIG. 2) that create a funnel shaped passage when the phenolic laminates 200a-200c are stacked. The phenolic laminates 200d-200e shown in FIGS. 4D and 4E each include circle-shaped cavities 202d-202e, that are sized substantially equivalent to one another. The phenolic laminate 200f illustrated in FIG. 4F includes a circular cavity 202f having beveled walls. The phenolic laminate 200g in FIG. 4G also includes a circular cavity, however the cavity 202f does not have beveled walls. With regard to FIG. 4H, the phenolic laminate 200h has an oblong-shaped cavity 202h that extends across most of the laminate 200h and at least extends to the right-hand side of the laminate 200h to communicate with phenolic laminate 200g when the two laminate 200g and 200h are stacked on top of one another. FIGS. 41 and 4J provide circular-shaped cavities 202i and 202j that are located toward the left side of the laminate and communicate with cavity 200 when stacked below phenolic laminate 200h.

The cavities 202a-202j each has inlets and outlets located on either side of the laminates 200a-200j. As shown in FIG. 2, the inlets and outlets adjoin one another. In one preferred embodiment, the adjoining inlets and outlets are substantially similarly sized to provide a smooth transition from cavity to cavity when the laminates 202a-202c are stacked. However, this is not a requirement.

As will be appreciated by those with skill in the art, the cavities may be formed into the phenolic laminates 202a-202j in any one of numerous methods. For example, the phenolic laminates 202a-202j may be sawed, milled, stamped, or machined. Alternatively, the laminates may be molded into a preferred shape that includes a cavity.

Returning to FIG. 3, adhesive is applied to each phenolic laminate 200a-200j so that each laminate may be bonded together (330). The adhesive is preferably a thermosetting unsupported nitrile phenolic structural film adhesive, such as SCOTCH-WELD™ AF-31 (available through the 3M Corporation of Minnesota) or PLASTILOCK® 655-1 (available through SIA Adhesives, Inc., a division of Sovereign Specialty Chemicals, of Akron, Ohio), however, thermosetting modified epoxy structural film adhesives and bismaleimide epoxy structural film adhesives, or any one of numerous other types of adhesives capable of maintaining a bond between two phenolic structures in a high temperature environment may be used as well. Moreover, although film adhesives are preferred, other types of adhesives, such as paste adhesives, may be employed, including but not limited to, those referred to in U.S. patent application Ser. No. 10/650,166 filed Aug. 27, 2003 entitled “Ablative Composite Assemblies and Joining Methods Thereof”, which is incorporated herein by reference.

No matter the specific adhesive that is used, the adhesive may be applied to the phenolic laminates 200a-200j by any one of a number of processes. In one exemplary embodiment, a film adhesive having two sides each with adhesive surfaces is used. The film adhesive is cut so that its size and shape corresponds with the size and shape of the phenolic laminate to which it will bond. Next, the surface of the phenolic laminate is prepared. In one embodiment, the surface of the phenolic laminate is abraded to provide a rough surface. Any one of numerous known methods for abrading a surface may be used, such as sanding, grinding, and etching. After the surface is suitably abraded, the abraded surface is treated with a volatile solvent to remove unwanted debris that may be lingering from the abrading process. Suitable solvents include, but are not limited to, for example methyl ethyl ketone, isopropyl alcohol, and deionized water. Subsequently, the solvent is evaporated by air drying, blow drying, or heat. One of the adhesive surfaces of the film adhesive is joined to the abraded surface.

To join two phenolic laminates, a second phenolic laminate is appropriately aligned with the first phenolic laminate. For instance, the two laminates may have cavities formed therein that are intended to be in fluid communication with one another; thus, the cavities are aligned accordingly. The surface of the second phenolic laminate is prepared in a manner similar to that discussed above. The abraded surface of the second phenolic laminate is joined to the other adhesive surface of the film adhesive.

In the case of joining more than two phenolic laminates, a third phenolic laminate is needed. It will be appreciated that the each of the laminates to be used may include a variety of cavity shapes that, when stacked, form a channel having a particular shape. Thus, each laminate is stacked in a predetermined order and in a predetermined configuration (340).

In one exemplary embodiment of the method, after the first and second phenolic laminates are adhered to one another, the exposed surface of the second phenolic laminate is abraded. However, as those with skill in the art may appreciate, both sides of the second phenolic laminates may be abraded prior to being joined with any film adhesive. The third phenolic laminate is appropriately aligned with the second phenolic laminate and an adhesive film having a configuration similar to the second phenolic laminate is used to bond the two laminates together. After the laminates are appropriately stacked, a component is formed, which is the valve nozzle 124 in this embodiment.

To ensure adhesion between the layers, in one exemplary embodiment, opposing forces are applied to opposite surfaces of the component, pressing the laminates against one another to improve bonding therebetween. In yet another exemplary embodiment, additional features are machined into or coupled to the component. For example, beveled surfaces may be machined into the ends of phenolic laminates 202a and 202b of the valve nozzle 124 of FIG. 2 to obtain a valve nozzle 124 shape similar to the valve nozzle 124 depicted in FIG. 1. In still yet another example, the component is integrated into the missile.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for fabricating a missile component having a flow path therein, the method comprising:
bonding a plurality of phenolic laminates to one another in a predetermined order and in a predetermined configuration, each phenolic laminate having a cavity formed therein,
wherein the bonded phenolic laminates form the missile component and the cavities define the flow path.

2. The method of claim 1, wherein the step of stacking and bonding comprises:
abrading a surface of each one of the plurality of phenolic laminates;
removing debris from the abraded surface; and
applying an adhesive to the abraded surface.

3. The method of claim 1, further comprising:
pressing at least one of the plurality of phenolic laminates against another.

4. The method of claim 1, further comprising:
machining the cavities into at least one of the plurality of phenolic laminates, before stacking and bonding the phenolic laminates.

5. The method of claim 1, further comprising:
machining features into the stacked and bonded phenolic laminates.

6. The method of claim 1, wherein the step of stacking and bonding comprises applying an adhesive to at least one of the plurality of phenolic laminates.

7. The method of claim 6, wherein the adhesive comprises at least one of a film adhesive, a paste adhesive, an epoxy, and a resin.

8. The method of claim 7, wherein the film adhesive comprises one of a thermosetting unsupported nitrile phenolic structural film adhesive, a thermosetting modified epoxy structural film adhesive, and a bismaleimide epoxy structural film adhesive.

9. A method for fabricating a missile component comprising:
stacking a first phenolic laminate having at least one cavity on top of a second phenolic laminate, the cavity having a predetermined shape; and
adhering the first and second phenolic laminates to one another.

10. The method of claim 9, wherein the step of stacking and bonding comprises:
abrading a surface of one of the phenolic laminates;
removing debris from the abraded surface; and
applying an adhesive to the abraded surface.

11. The method of claim 9, further comprising:
pressing the phenolic laminates against one another.

12. The method of claim 9, further comprising:
machining the cavities into one of the phenolic laminates, before the step of stacking.

13. The method of claim 9, further comprising:
machining features into the stacked and adhered phenolic laminates.

14. The method of claim 9, wherein the step of adhering comprises applying an adhesive to at least one of the plurality of phenolic laminates.

15. The method of claim 14, wherein the adhesive comprises at least one of a film adhesive, a paste adhesive, an epoxy, and a resin.

16. The method of claim 15, wherein the film adhesive comprises one of a thermosetting unsupported nitrile phenolic structural film adhesive, a thermosetting modified epoxy structural film adhesive, and a bismaleimide epoxy structural film adhesive.

17. A method for fabricating a missile component having a flow path therein, the method comprising:
applying an adhesive to a first one of a plurality of phenolic laminates, each laminate having at least one cavity formed therein;
aligning the cavity of a second one of the plurality of phenolic laminates with at least a portion of the cavity of the first phenolic laminate; and
pressing the first and second phenolic laminates against one another to bond the first and second laminates together.

18. The method of claim 17, wherein the step of applying an adhesive comprises:
abrading a surface of the first one of the plurality of phenolic laminates;
removing debris from the abraded surface; and
applying the adhesive to the abraded surface.

19. The method of claim 17, further comprising:
machining the cavities into at least the first one of the plurality of phenolic laminates, before stacking and bonding the phenolic laminates.

20. The method of claim 17, further comprising:
machining features into the pressed phenolic laminates.

21. The method of claim 17, wherein the adhesive comprises at least one of a film adhesive, a paste adhesive, an epoxy, and a resin.

22. The method of claim 21, wherein the film adhesive comprises one of a thermosetting unsupported nitrile phenolic structural film adhesive, a thermosetting modified epoxy structural film adhesive, and a bismaleimide epoxy structural film adhesive.
